(19) United States
(12) Patent Application Publication
(10) Pub. No.: US 2005/0265027 A1
(43) Pub. Date: Dec. 1, 2005

(54) LIGHT SOURCE MODULE OF PROJECTORS

(76) Inventors: Jeng-Yih WU, I-Lan Hsien (TW); Shih-Hui CHEN, Hsin-Chu City (TW); Yi Wei Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/709,845

(22) Filed: Jun. 1, 2004

(51) Int. Cl. F21V 9/00; F21V 1/00

(52) U.S. Cl. 362/293; 362/268

(57) ABSTRACT

A light source module includes a light source for generating light beams, a first lens array positioned on a side of the light source, and an invisible-light cut filter positioned on a side of the first lens array away from the light source, wherein the invisible-light cut filter is nonparallel with the first lens array.

### BACKGROUND OF INVENTION

1. Field of the Invention

The invention relates to a light source module, and more particularly, to a light source module of projectors which is capable of lengthening the lifetime of projectors.

2. Description of the Prior Art

With the arrival of the multimedia age, the use of various display devices has become more and more popular in every field. Particularly, a projection display device, such as a projector, is a notable device because it can contain a large-sized screen so that many people can see multimedia information at the same time. Generally speaking, there are several complex devices installed in a projector, such as a light source module, a photoelectric device, and a color separation optical system. The light source module provides a light source for projection of the projector, and therefore it is one of the important devices of the projector.

Please refer to FIG. 1, which is a schematic diagram of a light source module 10 according to the prior art. The light source module 10 comprises a light source 12, and an invisible-light cut filter 14, a first lens array 16, a second lens array 18, and a PS converter 20 positioned in sequence along the propagating direction of light beams from the light source 12. The first lens array 16 and the second lens array 18 provide functions of uniforming light beams generated from the light source 12. The PS converter 20 is used for polarizing light beams. Generally, the light source 12 used in a projector is an extra-high pressure mercury lamp that generates light comprising visible light and invisible light, such as ultraviolet (UV) light and infrared (IR) light. Since the UV and IR lights are harmful to human eyes and organic elements of the projector, the invisible-light cut filter 14 is installed near the light source 12 for protecting users and lengthening the lifetime of the other devices of the projector.

However, the invisible-light cut filters 14 currently used are all reflective cut filters. Therefore, when light beams irradiate from the light source 12 to the invisible-light cut filter 14, invisible light of the light beams is reflected directly to the vicinity of the light source 12. On the other hand, for a conventional light source module 10 of projector, there is a reflective housing 22 positioned around the light source 12 for reflecting light beams irradiating from the light source 12 with various angles so as to make these light beams propagate in a same direction out of the reflective housing 22, toward the first and the second lens array 16, 18. Therefore, when the UV and IR light is reflected back to the vicinity of the light source 12 by the invisible-light cut filter 14, most of the light is further reflected to the light source 12 if UV and IR light is first reflected to the surface of the reflective housing 22 around the light source 12. Accordingly, the load of the light source 12 increases, as well as the temperature of the light source 12. As a result, the lifetime of the light source 12 is shortened. The situation is even more serious when the light source 12 is a closed type.

### SUMMARY OF INVENTION

It is therefore a primary objective of the claimed invention to provided a light source module that has an invisible-light cut filter positioned at a specific position with a specific arranging direction so as to reduce the amount of invisible light reflected to the light source and further to lengthen the lifetime of the light source. Therefore the above-mentioned problem of a prior art light source module of projectors can be solved.

According to the claimed invention, the light source module comprises a light source for generating light beams, a first lens array, and an invisible-light cut filter, wherein the first lens array is positioned on a side of the light source, and the invisible-light cut filter is positioned on a side of the first lens array away from the light source. The invisible-light cut filter is nonparallel with the first lens array.

It is an advantage of the claimed invention that the invisible-light cut filter is installed at a position farther away from the light source than prior art, and the invisible-light cut filter is inclined corresponding with the first lens array and is arranged to be nonparallel with the first lens array, so that most of invisible light will not be reflected into the reflective housing and to the vicinity of the light source. Accordingly, the energy of invisible light reflected back to the light source will be effectively decreased and the lifetime of the light source module will be thereby lengthened.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of a light source module according to the prior art.

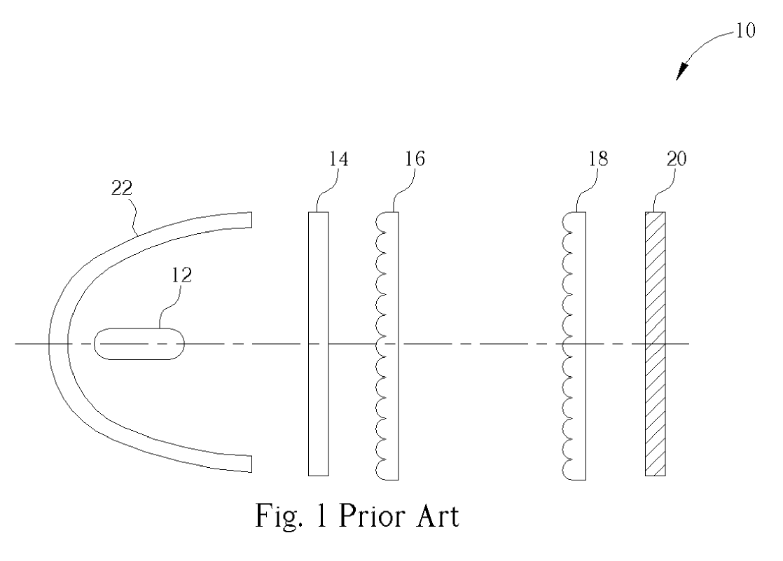

FIG. 2 is a schematic diagram of a light source module according to the present invention.

FIG. 3 is a schematic diagram of a light source module of a second embodiment according to the present invention.

### DETAILED DESCRIPTION

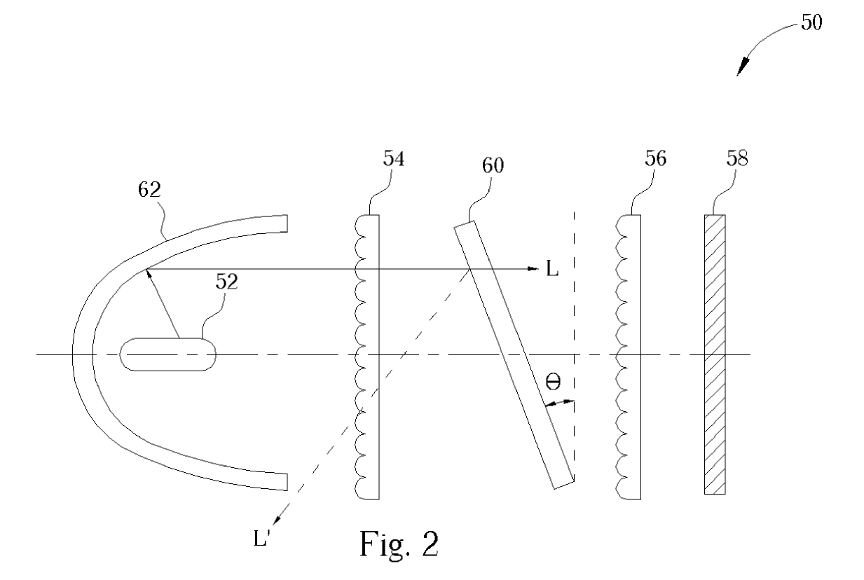

Please refer to FIG. 2, which is a schematic diagram of a light source module 50 according to the present invention. The light source module 50 comprises a light source 52 for generating light beams, a first lens array 54, a second lens array 56, and a PS converter 58 positioned in front of the light source 52 in sequence and arranged parallel with each other. The light source 52 is an extra-high pressure mercury lamp, which has an operating pressure of 100 atmospheres (atm). The light source module 50 further comprises an invisible-light cut filter 60 positioned between the first lens array 54 and the second lens array 56 and arranged nonparallel with the first lens array 54. As shown in FIG. 2, the invisible-light cut filter 60 and a direction parallel with the first lens array 54 have an included angle θ, which is an acute angle. The invisible-light cut filter 60 is formed of a glass plate having a film (not shown) thereon, wherein the film filters invisible light, such as UV or IR light. Accordingly, when light beams irradiate from the light source 62 to the invisible-light cut filter 60, visible light passes through the invisible-light cut filter 60 to the second lens array 56 without changing paths, but invisible light is reflected by the film of the invisible-light cut filter 60, wherein the reflection angle is the same as the incident angle of the invisible light to the invisible-light cut filter 60.

The light source module 50 further comprises a light source housing 62 surrounding a portion of the light source 52 for reflecting light beams irradiating from the light source 52 with various angles so that all of the reflected light beams propagate toward the first lens array 54. In FIG. 2, a light beam L is illustrated for explanation. As shown in FIG. 2, the light beam L irradiates from the light source 52 to the light source housing 62, and then is reflected by the light source housing 62 to propagate in a direction parallel with the normal of the first lens array 54. After passing through the first lens array 54, visible light of these light beams continues to propagate along the direction parallel with the normal of the second lens array 56, and invisible light of these light beams is reflected by the invisible-light cut filter 60. Since the reflection angles of the reflected invisible light are the same as the incident angles, the reflected invisible light is easily propagated out of the light source housing 62 when the invisible-light cut filter 60 is arranged in an inclined angle. Accordingly, the load of energy of the light source 52 can be effectively reduced when the light source 52 is lit up, and the light source 52 does not have to be directly exposed to the reflected invisible light. In this embodiment, the range of the included angle is preferably about 11 to 45 degrees.

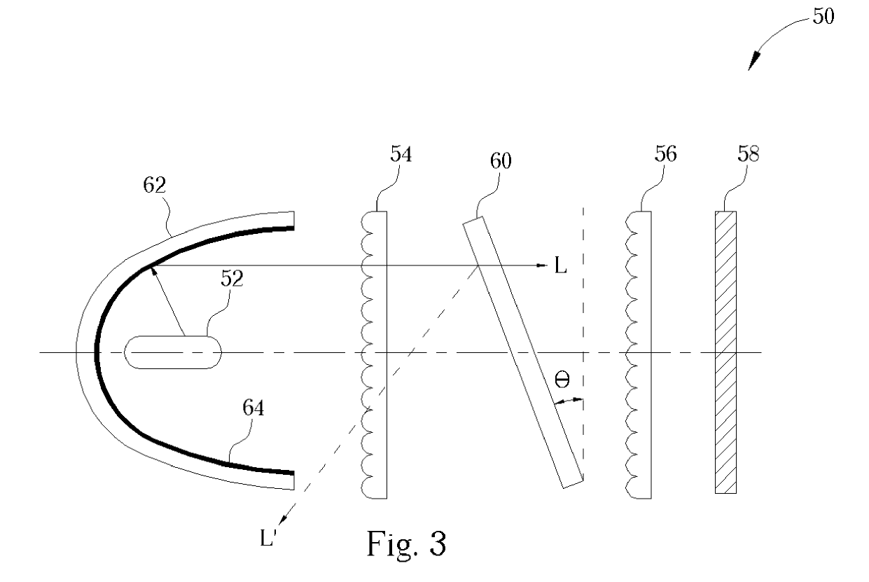

Referring to FIG. 3, FIG. 3 is a schematic diagram of a light source module of the second embodiment of the present invention. In this embodiment, the surface of the light source housing 62 is coated with an thin film 64 for filtering invisible light of light beams irradiating to the light source housing 62 so as to filter out a portion of the invisible light of light beams from the light source 52. When the light beam L irradiates from the light source 52 to the surface of the light source housing 62, a part of invisible light of the light beam L is filtered by the thin film 64. After that, the residual invisible light passes through the first lens array 54 together with visible light to reach the invisible-light cut filter 60, and at this time, most residual invisible light is reflected by the invisible-light cut filter 60 to outside of the light source housing 62 so that the internal temperature of the light source housing 62 can be maintained and the lifetime of the light source 52 can be lengthened.

It should be noted that the inclination direction and angle of the invisible-light cut filter 60 is determined according to the design of the light source module 50. For example, the inclination direction of the invisible-light cut filter 60 is not limited to any direction. In addition, although the invisible-light cut filter 60 can be positioned between the light source 52 and the first lens array 54 by an inclined way, most invisible light reflected by the invisible-light cut filter 60 may still propagate into the light source housing 62 because the distance between the first lens array 54 and the light source 52, or the light source housing 62, of the light source module 50 is too short. Furthermore, according to the limitation of the distance between the light source housing 62 and the first lens array 54, the invisible-light cut filter 60 cannot incline with a greater inclination angle when the invisible-light cut filter 60 is positioned between the light source 52 and the first lens array 54. Accordingly, the goal of reducing the amount of reflected invisible light propagating to the vicinity of the light source 52 cannot be matched since the included angle is too small.

In contrast to the prior, the present invention light source module comprises an invisible-light cut filter positioned between the first and the second lens array that has a longer distance from the first lens array so that the invisible-light cut filter can have a preferable inclination angle. Accordingly, the total amount of light reflected back to the light source can be reduced, and furthermore, the temperature inside the light source housing and the temperature of the light source can be effectively decreased. Consequently, the lifetime of the light source module can be lengthened and the elements of the light source module and other device of projectors can be also protected.

Those skilled in the art will readily observe that numerous modifications and alterations of the device and method may be made while retaining the teachings of the invention. Accordingly, the above disclosure should be construed as limited only by the metes and bounds of the appended claims.

1. A light source module comprising:
a light source for generating light beams;
a first lens array positioned on a side of the light source; and
an invisible-light cut filter positioned on a side of the first lens array away from the light source, the invisible-light cut filter being nonparallel with the first lens array.

2. The light source module of claim 1 further comprising a second lens array positioned on the same side of the light source as the first lens array.

3. The light source module of claim 2, wherein the second lens array is positioned on a side of the invisible-light cut filter away from the light source.

4. The light source module of claim 1 further comprising a PS converter positioned on a side of the invisible-light cut filter away from the light source.

5. The light source module of claim 1, wherein the invisible-light cut filter and a direction parallel with the first lens array have an included angle, the included angle being an acute angle.

6. The light source module of claim 5, wherein a range of the included angle is about 11 to 45 degrees.

7. The light source module of claim 1, wherein the invisible-light cut filter is used for reflecting ultraviolet (UV) and infrared (IR) light of the light beams.

8. The light source module of claim 1, wherein the light source is an extra-high pressure mercury lamp.

9. The light source module of claim 1 further comprising a light source housing surrounding a portion of the light source for reflecting the light beams so that the light beams propagate toward the first lens array.

10. The light source module of claim 1, wherein the light source module is applied to a projector.

11. A light source module of a projector comprising:
a light source for generating light beams;
a first lens array positioned on a side of the light source;
a second lens array positioned on a side of the first lens array away from the light source; and
an invisible-light cut filter positioned between the first lens array and the second lens array, the invisible-light cut filter and a direction parallel with the first lens array having an included angle, and the included angle being an acute angle.

12. The light source module of claim 11, wherein a range of the included angle is about 11 to 45 degrees.

13. The light source module of claim 11 further comprising a PS converter positioned on a side of the second lens array away from the light source.

14. The light source module of claim 11, wherein the invisible-light cut filter is used for reflecting UV and IR light of the light beams.

15. The light source module of claim 11, wherein the light source is an extra-high pressure mercury lamp.

16. The light source module of claim 11 further comprising a light source housing surrounding a portion of the light source for reflecting the light beams so that the light beams propagate toward the first lens array.
